(19) United States
(12) Patent Application Publication
(10) Pub. No.: US 2005/0038824 A1
(43) Pub. Date: Feb. 17, 2005

(54) Quality of service in asynchronous message transfer

(76) Inventors: Joachim Kenntner, Heidelberg (DE); Frank Thome, Karlsruhe (DE); Andreas Wildhagen, Wiesloch (DE); Frank Michael Kraft, Speyer (DE); Guenter Pecht-Seibert, Muehlhausen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/641,696

(22) Filed: Aug. 15, 2003

(51) Int. Cl. G06F 12/00

(52) U.S. Cl. 707/200

(57) ABSTRACT

Asynchronous transfer of messages between different computing systems is accomplished using an “exactly latest” quality of service type that is implemented in a message transport infrastructure. In one aspect, in response to an action in a first computing system affecting the current state of the document, a message containing the current state of the document is posted for delivery to an outgoing message channel in a message exchange layer contained within the first system. At a time for asynchronous message transfer, and if a first quality of service type is specified for the transfer of messages containing the current state of the document, only a latest message containing the document that is posted to the outgoing message channel is forwarded for transfer to a second system.

### TECHNICAL FIELD

This invention relates to quality of service techniques used in asynchronous message transfer between different computing systems.

### BACKGROUND

Enterprise information technology (IT) systems are composed of several, separate applications working independent of each other and linked via asynchronous messages. The messages may be exchanged, for example, using a messaging system (that is, middleware), and using store-and-forward message transfer. Quality of service refers to the manner by which messages are transferred to ensure their quality while also maintaining network efficiency. Two examples of quality of service types that are commonly used in messaging systems are quality of service types “exactly once” and “exactly once in order.”

Under an “exactly once” quality of service, each and every message pertaining to a particular message is transferred or used. Channels, which are used to maintain a specific order for successive related messages for which an order of the messages must be maintained, are not used in an “exactly once” quality of service type. As such, this quality of service type is not useful for transfers where a specific order of messages must be maintained. An example of messages where “exactly once” quality of service may be appropriate are transaction messages to a banking system. Assuming the messages contain debit or credit information for a banking account (that is, information of a scalar nature), then the order in which the messages are received in the destination system, the banking system, does not matter.

Under an “exactly once in order” quality of service, each and every message pertaining to the object or document is likewise required to be forwarded, but unlike the “exactly once” quality of service type, the messages must be processed in a specific order. As such, under this quality of service type, channels are typically used to aggregate all messages of a certain type, so that the order of the messages is kept during an asynchronous message transfer. Under the “exactly once in order” quality of service type, unnecessary message traffic may occur because later messages may obsolete earlier messages.

In various individual software applications, version handling techniques have been employed to discard obsolete versions of messages and replace them with current versions. Such version handlers examine a version identifier contained in the message, and based on that information, discard older versions of messages if newer versions are available. In addition, updating techniques are used to identify messages that are obsolete. For example, in Microsoft Outlook, it is possible to transmit a “meeting request” message to other email users. It is also possible to send an update message to the original Outlook meeting request message, for example to change the time or location of the meeting. If one of the recipients of the messages views an obsolete version of the meeting request message (that is, the original meeting request message), it is indicated in the message that the message is obsolete; this notifies the user that a more recent update of the meeting request exists.

### SUMMARY

The invention provides for the asynchronous transfer of messages between different computing systems using an “exactly latest” quality of service type that is implemented in a message transport infrastructure.

In one aspect, the invention provides a method of transferring messages containing the current state of a document, from a first system executing a first software application to a second system executing a second software application. In response to an action in the first system affecting the current state of the document, a message containing the current state of the document is posted for delivery to an outgoing message channel in a message exchange layer contained within the first system. At a time for asynchronous message transfer, and if a first quality of service type is specified for the transfer of messages containing the current state of the document, only a latest message containing the document that is posted to the outgoing message channel is forwarded for transfer to the second system.

In another aspect, the invention provides a computer program product containing executable instructions that when executed cause a processor to perform the following steps. First, in response to receiving, in a messaging transport layer, a message that contains a complete state of a document and that represents information to be transferred from a first computing system to a second computing system, the message is stored in a message channel designated for messages containing the document. Second, at a time for asynchronous message transfer, and if a first quality of service type is specified for the transfer of messages containing the current state of the document, only a latest message containing the document that is stored in the message channel is forwarded for transfer to the second system.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an enterprise information technology system in which message transfer techniques are employed.

FIG. 2 is a diagram showing an example protocol for a message, for example a message that may be transferred within the system of FIG. 1.

FIGS. 3A and 3B are flowcharts of a method of transferring messages between different computing systems, for example between the different computing systems shown in FIG. 1.

FIG. 4 is diagram illustrating the message transfer method shown in FIG. 3A as applied to an example sales application scenario.

FIGS. 5-7 are diagrams illustrating the contents of the message channels, shown in FIG. 1, during various different message transfer scenarios.

Like reference symbols in the various drawings indicate like elements.

### DETAILED DESCRIPTION

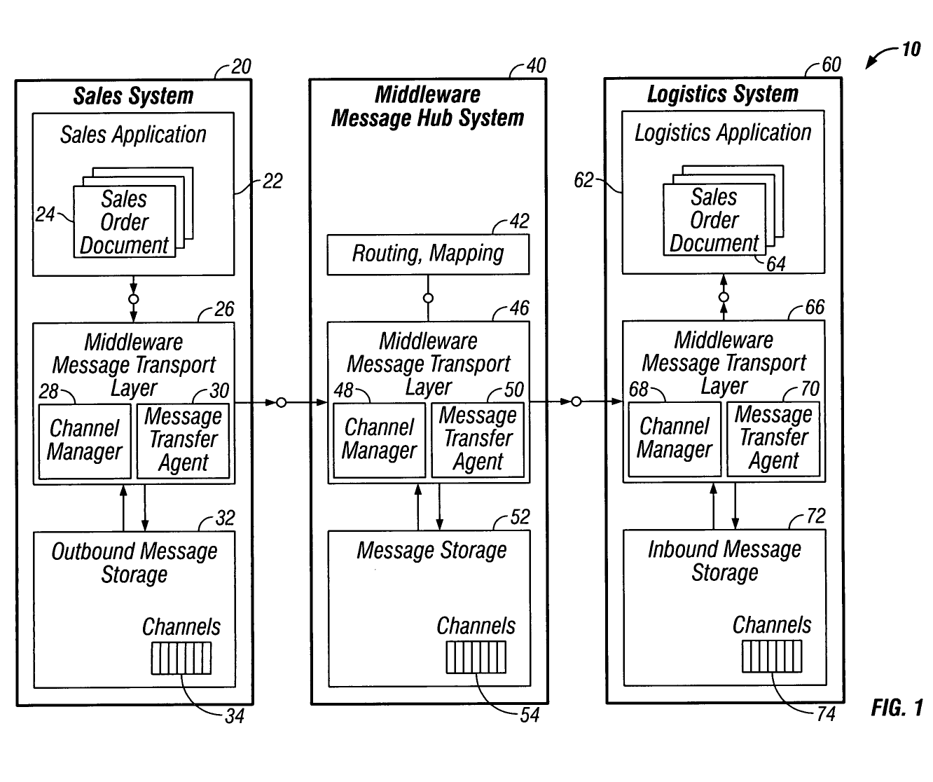

An enterprise information technology (IT) system 10, shown in FIG. 1, includes three networked computing systems, which in this example are a sales system 20, a middleware message hub 40, and a logistics system 60. Messages containing a current status of a document are transferred asynchronously from the sales system 20 and eventually to the logistics system 60, either directly or by way of the middleware message hub 40 as is depicted in FIG. 1. The messages are exchanged using a messaging system (that is, middleware) using store-and-forward message transfer. Although the message transfer technology that will be described in this document is described primarily in the context of a sales system 20 and a logistics system 60, it will be understood that the message transfer technology is applicable in many other types of systems.

The sales system 20 includes a sales software application 22, in which sales order documents 24, or sales order objects, are created and revised. The sales system 20 may be, for example, a computer system having a sales application thereon which is used by a salesperson. As such, the sales system 20 may be a mobile computing system such as a laptop computer. The sales system 20 may also be, for example, a computer system with a call center software application thereon, in which a sales agent enters sales order while talking to a customer on a telephone. Another example of a sales system 20 is an internet shop to which a user may connect, for example via the internet, and enter a sales order via a web interface. The sales system 20 may also have the capability to derive from a sales order document 24 information that is needed for delivery and package that information into a delivery request message, as will be described in more detail later.

The sales system 20 also includes a middleware message transport layer 26, which is part of the previously mentioned messaging system, or middleware, for the enterprise IT system 10. Information, such as a sales order document 24 or alternatively data derived from the sales order document such as delivery information, that needs to be forwarded to another system, such as the logistics system 60, first gets forwarded, or “posted,” by the sales application 22 to the message transport layer 26. This is illustrated in FIG. 1 by the arrows shown from the sales application to the middleware message transport layer 26. The information is forwarded in a message that contains a current state of the information. The information included in the message may be the sales order document itself, may be another document including only selected data from the sales order document, or may be yet another document derived from, or calculated from, information in the sales order document. For example, the message may contain the previously mentioned delivery request information that is pulled from, or derived from, the sales order document where the delivery request information includes only the information needed by the logistics system 60 to effect delivery of the purchased item. As an example of information included in a message that is derived from the sales order document, suppose the sales application 22 holds a sales order document 24 with n line items. In that case a message could contain an aggregated view of the sales order with a sum of prices over all line items, instead of all line items individually. As such, the derived information or document and the object, or document, from which the derived document is based may look similar but they may not be equal. Whatever the case may be, the information contained in the message will be referred to herein as a document.

The middleware message transport layer 26 includes a channel manager 28, a message transfer agent 30, and an outbound message storage 32 which includes a number of channels 34. Briefly, the channel manager 28 processes a posted message and stores the message in a channel within the outbound message storage 32. In particular, the channel manager 28 either creates a new outbound message channel in which to store the posted message if a channel for the particular document being posted in the message payload has not previously been created, or stores the posted message in a previously created outbound message channel if a channel had previously been created. The channel manager 28 may also control the quality of service for the message transfer in a manner that will be described in more detail later. Briefly though, the channel manager 28, as part of the middleware message transport layer 26, may control, or specify, the quality of service, and as such, the software application 22 need not be aware of the quality of service being used. Alternatively, the software application 22 may itself specify the quality of service that is implemented by the middleware message transport layer 26. This may be done by the software application 22 providing the information to the middleware layer 26 during runtime, for example, using an application programming interface (API) call as will be described later.

A separate channel in the channels 34 is created for each different document that is posted as payload of messages by the sales application 22 to the middleware message layer 26. For example, in the example where the message includes a sales order document (or delivery execution request document), there would be a different channel for each sales order document. However, it should be mentioned that there may be different versions of the same sales order document, for example where the sales order document (or delivery execution request document) is updated with additional information or where it is corrected, and different messages with these two versions of the same sales order document would be posted in the same outbound message channel.

The message transfer agent 30 controls the forwarding of messages from the outbound message storage 32 for eventual receipt by the logistics system 60. In the FIG. 1 example, it is shown that the messages are forwarded first to the middleware message hub system 40 en route to the logistics system 60. This is just an example of how a message may be routed to another system. Alternatively, messages may be transferred directly between system 20 and 60.

The middleware message hub system 40 serves as a central messaging center for the entire enterprise IT system 10. In many cases it is desirable to utilize such a message hub system 40. For example, a system within the enterprise system 10 may send messages to several other systems. Instead of having a direct connection to each system to which the system transfers messages, the system need only be interconnected with the middleware message hub system 40. Then from the hub system 40, the message may be forwarded to its eventual destination. It will be appreciated that in FIG. 1, for simplicity, only two systems 20 and 60 and associated software applications 22 and 62 are shown, but in an actual enterprise IT system, there may be many more systems and applications, and each system may communicate with multiple other systems within the overall enterprise IT system.

The message hub system 40 includes a routing and mapping software application 42 and a middleware message transport layer 46. The routing and mapping software application 42 performs two main functions. First, the application 42 determines where a received message is to be forwarded, or routed, to reach its ultimate destination. Second, the application 42 performs a mapping function, if necessary. For example, if the data format used by the logistics system 60 differs from that used by the sales system 20, then the application 42 may translate the format for a received message into a format that can be understood by the logistics system 60.

The message hub system's message transport layer 46 is part of the previously mentioned messaging system, or middleware, for the enterprise IT system 10, and is similar in function to the message transport layer 26 in the sales system 20. The message transport layer 46 includes a channel manager 48, a message transfer agent 50, and message storage 52 that includes a number of channels 54. The channel manager 48 processes a received message and stores the message in a channel within the outbound message storage 52, and as part of that process either creates a new message channel in which to store the received message or stores the received message in a previously created message channel. The channel manager 48 also controls the quality of service for the message transfer in a manner that will be described in more detail later. As with the sales system transport layer 26, a separate channel in the channels 54 is created for each different document that is received. The message transfer agent 50 controls the forwarding of messages from the message storage 52 for eventual receipt by the logistics system 60. In the FIG. 1 example, it is shown that the messages are forwarded from the middleware message hub system 40 directly to the logistics system 60.

The logistics system 60 includes a logistics software application 62, in which sales order documents 64, or sales order objects, are processed to fulfill and execute the sales order. Alternatively, the logistics software application 62 may receive only the delivery information for a sales order document, and may process that information to effect delivery. The logistics system 60 may be, for example, a software application used by an order fulfillment center. In this example, the information from the sales order document 64 may be used to effect the proper delivery of the product or service that has been sold.

The logistics system 60 also includes a middleware message transport layer 66, which is part of the previously mentioned messaging system, or middleware, for the enterprise IT system 10. The message transport layer 66 is similar in function to the message transport layers 26 and 46 in the sales system 20 and in the middleware message hub system 40. In particular, the message transport layer 66 includes a channel manager 68, a message transfer agent 70, and inbound message storage 72 that includes a number of channels 74. The channel manager 68 processes a received message and stores the message in a channel within the inbound message storage 72, and as part of that process either creates a new inbound message channel in which to store the received message or stores the received message in a previously created inbound message channel. The channel manager 68 also controls the quality of service for the message transfer in a manner that will be described in more detail later. As with the sales system transport layer 26 and the message hub system transport layer 46, a separate channel in the channels 74 is created for each different document that is received. The message transfer agent 70 controls the forwarding of messages from the message storage 72 for eventual processing by the logistics application 62.

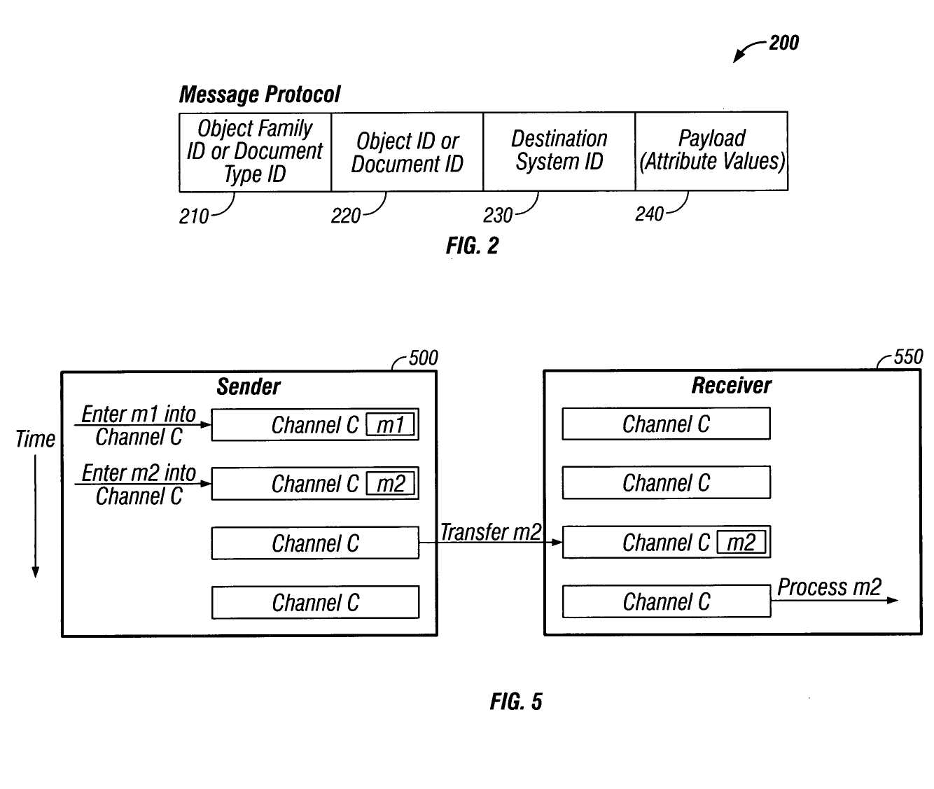

Before discussing the additional detail regarding the method by which messages are transferred within the enterprise IT system described in FIG. 1, it is first helpful to describe an example format that may be used for the messages. Referring to FIG. 2, an example message format is shown, in simplified form. In FIG. 2, a message 200 includes an object family identifier or document type identifier 210, which may be a unique identifier that identifies the type of object or type of document. For example, for a sales order object, the family, or type, identifier 210 may identify that the object is of a sales order object type, as opposed to some other type of object. As will be explained later, the object family identifier or document type identifier 210 may be used to determine by a middleware message transport layer (such as layers 26, 46 and 66 in FIG. 1) to determine the type of quality of service to apply to the message. Alternatively it is possible that the software application program 22 specify the quality of service to be implemented in message transport layers 26, 46 and 66 during the transport of the message.

In this alternative, the message may also include an identifier for the quality of service, or alternatively, the software application program 22 may specify the quality of service in some other way, such as by an API call.

Next, the message 200 includes an object identifier or document identifier 220. The object identifier 220 uniquely identifies the specific object or document. In the example of the sales order document, the object identifier 220 identifies a specific sales order document, although there may be several versions of the same sales order document. Next, the message includes a destination system identifier 230, which identifies the system to which the message is to be transferred. Finally, the message 200 includes a payload 240, or in other words, values and information corresponding to various object attributes. For example, in the case of a sales order document, the payload may include information such as the identity and address of the buyer, the goods that have been purchased, delivery instructions, etc.

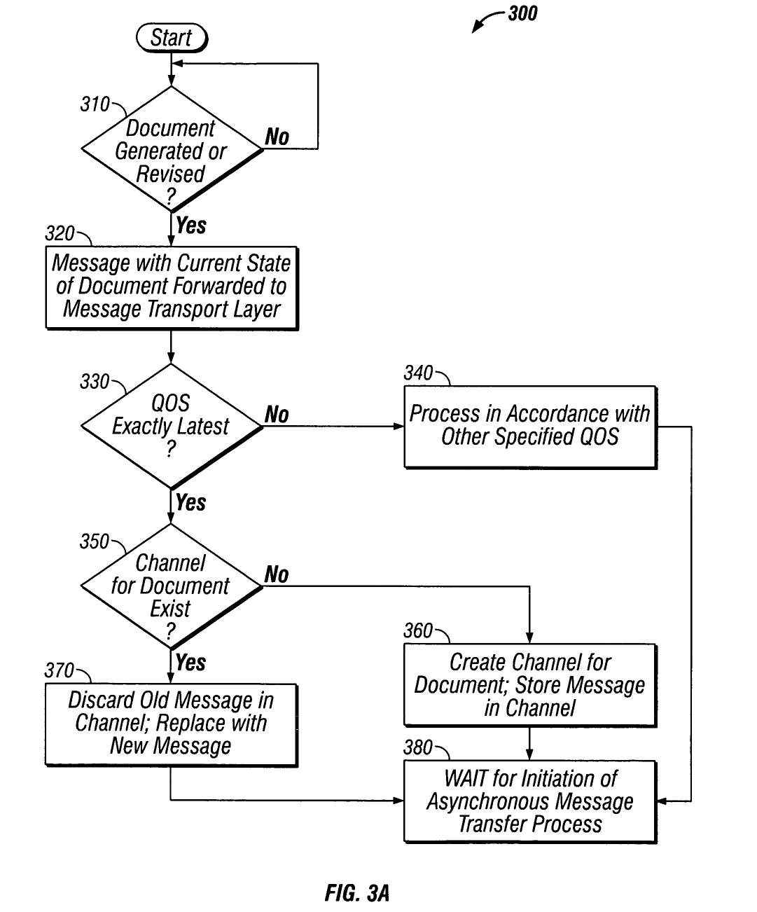

Referring now to FIGS. 3A and 3B, flow charts are shown that depict an example of the message transfer method. Briefly, FIG. 3A shows a transfer method 300 from the perspective of a sending system, and FIG. 3B shows a method 305 from the perspective of a receiving system.

In FIG. 3A, the sending system method 300 begins, at step 310, with the generation, or revision, of a document. In the example of the sales system 20, this may be the creation, or revision, of a sales order document 24. When this occurs, the current state of certain data—such as the information in the sales order document, selected information from the sales order document, or information derived from the sales order document —is forwarded, at step 320, in a message to a message transport layer, such as the layer 26 in the FIG. 1 example.

Upon receipt of the message by the message transport layer, it is determined, at step 330, whether the type of quality of service for the document (and thus for the messages containing the document) has been specified to be “exactly latest.” In one example, the quality of service type is specified during the design of the business process performed by the system. Later at runtime, the determination of the quality of service type may be performed, in the FIG. 1 example, by the channel manager 28. The channel manager 28 may determine the type of quality of service by looking at the object family identifier or document type identifier 210 (see FIG. 2), and determining from that identifier 210 whether the object family or document type to which the document belongs has been assigned to the “exactly latest” quality of service type. Alternatively, the quality of service may be specified by the application 22.

If the quality of service type is not specified to be “exactly latest,” then the processing proceeds to step 340 where the processing of the message is conducted in accordance with the specified quality of service type, if any specific type has been specified. Other quality of service types that may be specified include, for example, “exactly once” or “exactly once in order.” Under an “exactly once” quality of service, each and every message pertaining to the document is forwarded or used, and channels for the different documents need not be created because ordering is determined to not be important. An example of a type of information where “exactly once” quality of service may be appropriate are transactions in a banking system. Assuming the message contains debit or credit information to a banking account, then the order in which messages are received in the destination system (that is, the banking system) does not matter. Under an “exactly once in order” quality of service, each and every message pertaining to the document is also forwarded, but unlike the “exactly once” quality of service type, the messages must be forwarded in order. As such, under this quality of service type, channels are typically used to aggregate all messages of a certain document and to ensure their order is kept during transfer.

If the quality of service type is specified to be “exactly latest,” then it is determined, at step 350, whether a channel for the document exists. In the example of FIG. 1, this step may be performed by the channel manager 28, which looks at the document identifier 220 (see FIG. 2) for the document, or alternatively it may have been specified by the application 22 as to which quality of service type should be used, as previously discussed. Each channel may have assigned to it a document identifier 220 for the message containing that document that is associated with the channel. As such, the channel manager 28 looks to the document identifier 220 contained in the received message and checks whether a channel with that document identifier 220 exists. If a channel for the document does not exist, then a channel is created for the document and the message is stored in the channel (step 360). If, however, it is determined at step 350 that a channel for the document does indeed already exist, this means that a message containing an earlier version of the document is currently stored in a channel that was created for the document. As such, at step 370 the message containing the earlier version of the document is discarded and is replaced with the more recent (or latest) message.

Following the processing at either step 340, 360 or 370, the process waits, at step 380, until initiation of an asynchronous message transfer process. During the wait, it may be that another message with a new current state for the document may be generated because, for example, the object from which the document is derived may have been revised, in which case the process would start again from step 310 and the message in the channel may get replaced by a more recent message.

Referring now to FIG. 3B, the receiving system method 305 begins, at step 315, with the initiation of an asynchronous message transfer process, for example when a mobile user of a sales application logs into a network. When this occurs, the message that is stored in an outbound channel is transferred via the messaging system to another system. In the FIG. 1 example, this step 315 involves the transfer of a message stored in outbound channel 34 of the sales system to the middleware transport layer 46 of the middleware message hub system 40. Alternatively, the message may be transferred to the middleware transport layer 66 of the logistics system 60. If the quality of service type for the document was assigned in the middleware layer for the sending system to be “exactly latest,” then only one message from each channel will be transferred, and the transferred message will be the message containing the latest version of the document that was stored in the channel.

Upon receipt of the message by the receiving system's message transport layer 46 or 66, it is determined, at step 335, whether the type of quality of service for the document has been specified to be “exactly latest.” As discussed in connection with the sending system, the quality of service type may be specified during the design of the business process performed by the system. Then at runtime, the determination of the quality of service type may be performed, in the FIG. 1 example, by the channel manager 48 or 68. The channel manager 48 or 68 may determine the type of quality of service by looking at the object family identifier or document type identifier 210 (see FIG. 2), and determining from that identifier 210 whether the object family or document type to which the document belongs has been assigned to the “exactly latest” quality of service type.

As mentioned previously, the quality of service type may alternatively be determined on the sending system by the software application. Once the quality of service type has been determined, that information may be passed as control data in a control structure passed between systems. Each messaging infrastructure typically has such control structures, which usually also contain quality of service information for “exactly once” or “exactly once in order.” This means that the quality of service need not be determined again and again. However, in some systems where, for example, a sending system does not support a quality of service of “exactly latest,” but does support a quality of service of “exactly once in order,” the quality of service may be determined at some later intermediate point on the communication path.

Referring again to FIG. 3B, if the quality of service type is not specified to be “exactly latest,” then the processing proceeds to step 345 where the processing of the message is conducted in accordance with the specified quality of service type, such as “exactly once” or “exactly once in order.” If, on the other hand, the quality of service type is specified to be “exactly latest,” then it is determined, at step 355, whether a channel for the document already exists. In the example of FIG. 1, this step may be performed by the channel manager 48 or 68, which looks at the document identifier 220 (see FIG. 2) for the message and checks whether a channel with that document identifier 220 exists. If a channel for the document does not exist, then a channel is created for the document and the message is stored in the channel (step 365). If, however, if it is determined at step 355 that a channel for the document does exist, this means that a message containing an earlier version of the document is currently stored in a channel that was created for the document. As such, at step 375 the message containing an earlier version of the document is discarded and is replaced with the more recent (or latest) message.

Following the processing at either step 345, 365 or 375, the process waits, at step 385, until initiation of an asynchronous message transfer process (in the example of the message hub system 40) or for the initiation of processing of the message (in the example of the logistics system 60). During the wait, it may be that another message with a new current state for the document may be received because, for example, the object from which the document is derived may have been revised, in which case the process would start again from step 315.

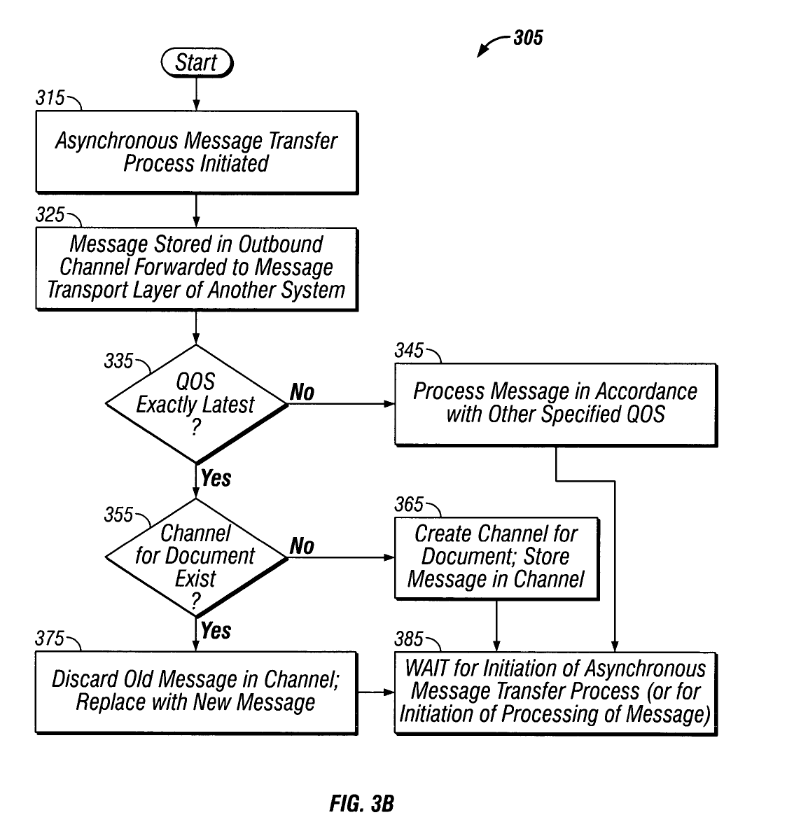

Referring now to FIG. 4, a diagram is provided that illustrates the message transfer method in the context of the enterprise IT system 10 of FIG. 1. The diagram shows an example where a customer 400 creates a sales order (or purchase order), at step 405, for example in an Internet sales system. In such an example, the customer 400 may use an Internet web interface to enter a sales order in a web shop. The sales application 22 then forwards a delivery execution request document 410 to the sales application middleware layer 26. The delivery execution request document 410 may be derived from the sales order document, and may be updated every time that the sales order document is updated with information affecting the information in the delivery execution request document 410.

The forwarding of the delivery execution request document 410 to the middleware layer 26 may be done, for example, by calling a proxy function in the middleware layer 26. When called for the first time, the proxy function in the middleware layer 26 creates a message “m1” of the current state of the sales order document or delivery execution document and passes that message, at 415, to the channel manager 28. A proxy is typically some generated function or a Java method, macro or other piece of coding that is called from the application function (outbound) or to be implemented, or filled, with code by the application development (inbound). This approach makes the handling of the middleware layer 26 easier by hiding the internal and technical behavior. The message content, or payload, then usually is passed as some parameter or in a container, similar to an attachment or a string. The application 22 may alternatively create messages by filling some internal container and then calling a middleware layer 26 API. Proxies may also be used to fill the container and also call the middleware API. The channel manager 28, when the message is received, then checks for obsolete messages in channel C and stores the message “m1” in the assigned channel C.

Later the customer 400 may update the sales order document, at 420. For example, the customer 400 may decide to order some accessories to the original purchase, and connects to the internet shop again, opens the order and adds a new line item. The sales application 22 then forwards another delivery execution request document 425 to the sales application middleware layer 26, for example by calling the proxy function in the middleware layer 26. When called for the second time, the proxy function in the middleware layer 26 creates a message “m2” of the current state of the delivery execution request document and passes that message, at 430, to the channel manager 28, which checks for obsolete messages in channel C. The channel manager 28 determines, because the quality of service type is assigned to be “exactly latest,” that message “m1” became obsolete because of message “m2.” Hence, the channel manager 28 removes message “m1” from channel C and stores message “m2” in channel C.

At some later time (for example, at a scheduled time), the message transfer agent 30 processes channel C. The message transfer agent 30 forwards message “m2,” at 435, from the sales system 20 either directly to the logistics system 60 or with intermediate steps (hops) using store and forward message transfer.

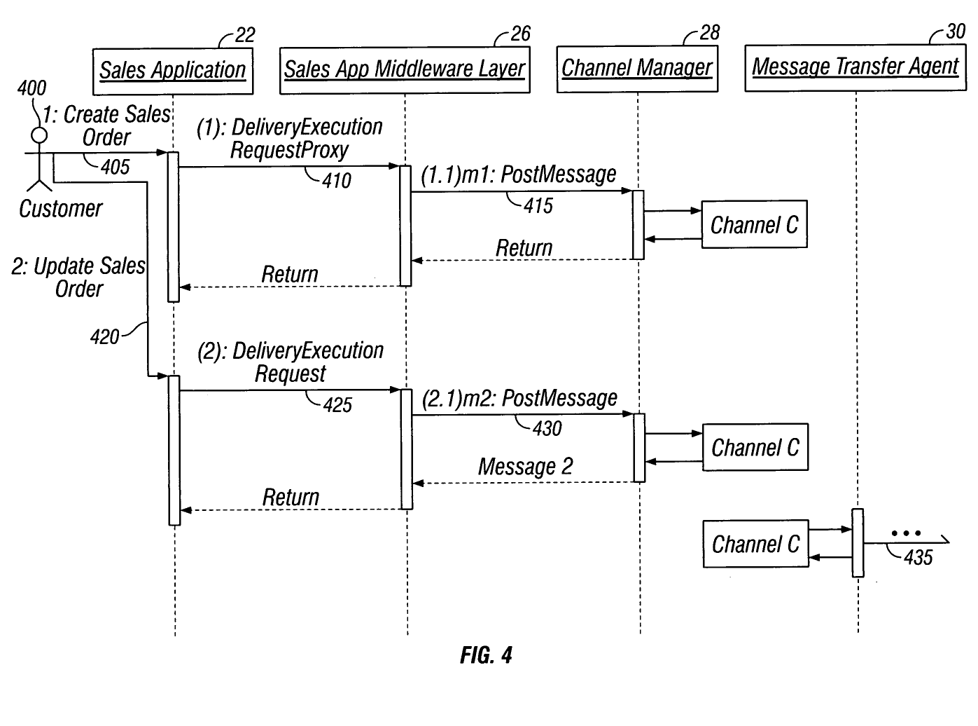

FIGS. 5-7 depict the channel handling in more detail. The channel handling allows entering messages into a channel. Until a message transfer agent transfers the message from the sending system to the receiving system, a message remains in the channel on the sender system side. While a message remains on the sender system side, it may be replaced by a more recent message entered into the channel. After transfer of a message to the receiving system, the message remains in the receiving system channel until the message is processed. The message does not need to be processed immediately on the receiving system side; for example, batch processing may be employed to utilize processing during times of low system usage, or may be required due to technical limitations of the receiving system.

FIG. 5 shows the channel handling where two messages are entered into a channel C before a transfer agent becomes active. In the example of FIG. 1, the channel handling may be performed by channel managers 28, 48 and 68. FIG. 5 shows the contents of a channel C in both a sending system 500 and a receiving system 550 at various points in time. First, a message “m1” is entered into channel C of the sending system 500, and thus at this time message “m1” is shown stored in sending system channel C. Next, another message “m2” is entered into channel C of the sending system 500. At this point in time, a channel manager detects the presence of message “m1” in the sending system channel C, and so message “m1” now becomes obsolete. As such, the channel manager removes message “m1” from channel C and places message “m2” into channel C, and so at this time only message “m2” is stored in the sending system channel C. At some later time, the transfer agent transfers message “m2” from the sending system 500 to the receiving system 550, and thus message “m2” is shown stored in channel C of receiving system 550. As the last step shown in FIG. 5, processing in the receiving system 550 is initiated, and thus message “m2” is processed by the receiving application.

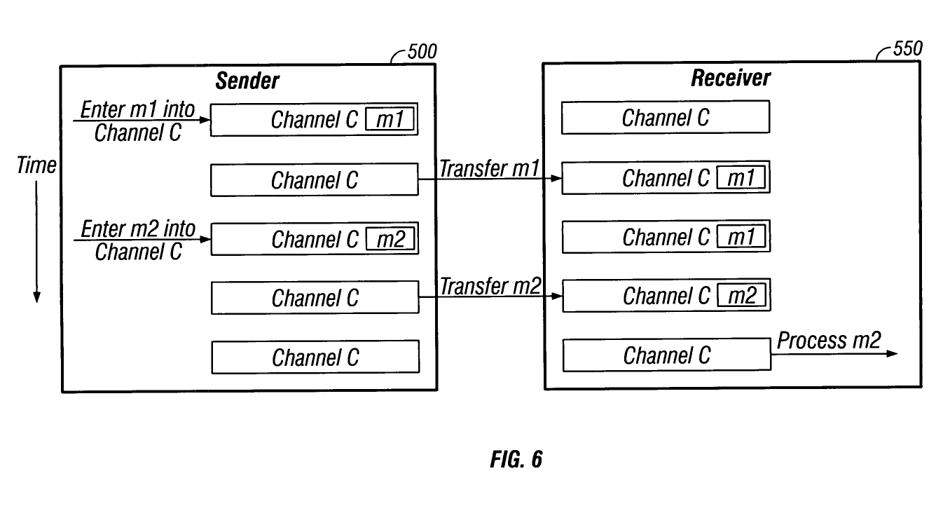

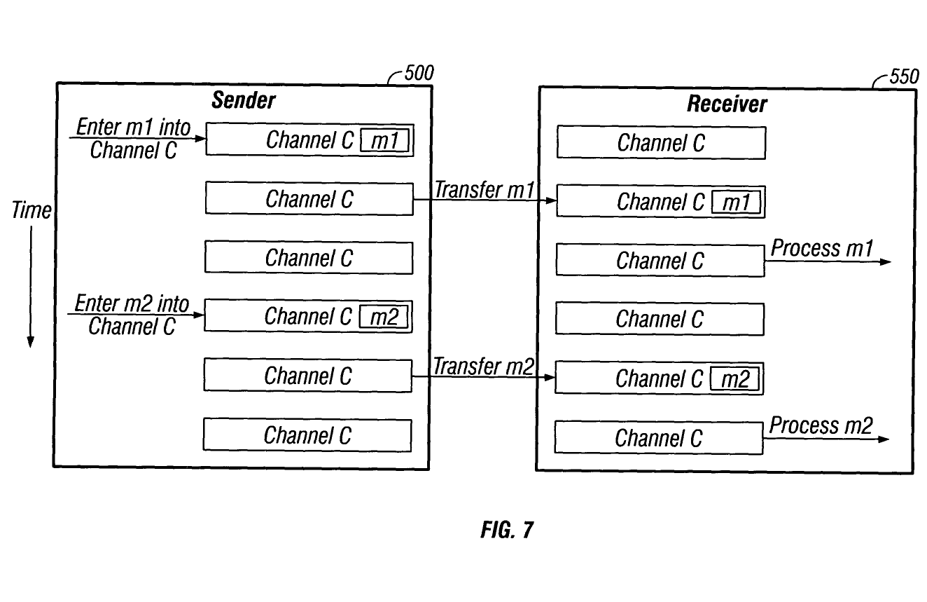

FIG. 6 depicts a case where message “m1” is transferred to the receiving system channel C before message “m2” is entered into the sending system channel C. Before message “m1” is processed, message “m2” is transferred to the receiver system channel C, where it replaces message “m1,” which still remained in the same channel. Finally, message “m2” is processed by the receiving application. FIG. 7 depicts a case where message “m1” is entered, transferred and processed before message “m2” is entered into channel C.

The concept of quality of service “exactly latest” gives the messaging transport layer the ability to detect outdated versions of messages and to discard obsolete messages. The advantage of having this functionality in the middleware layer is that the “exactly latest” quality of service can be specified transparent of the application on the sender side, on intermediate hubs, or at the receiver side.

A quality of service of exactly latest may offer various advantages compared to a quality of service of exactly once in order. Using the quality of service “exactly latest” omits unnecessary intermediate processing steps. Data volume may be reduced during communication, and application resource consumption may also be reduced. Channel congestion may be avoided in some cases where one message fails; for example, there may be self-healing if an error situation has been solved by a newer message replacing an erroneous message in a channel. Package processing of messages from several channels in the receiver system may be allowed because only the most recent message is received on the receiver system channel; in other words, keeping the order of multiple messages is not necessary.

Using the message transfer methods described herein, it is possible to have several transfer steps, or hops, and perform channel optimization in each node. For example, if only a sending system middleware layer supports the quality of service type “exactly latest,” but an intermediate system or receiving system middleware layer does not support this quality of service type, then the middleware layer can use an “exactly once in order” quality of service type instead of the “exactly latest” quality of service type. This is possible without a modifying the sending system application.

A number of embodiments of the invention have been described. Nevertheless, it will be understood that various modifications may be made without departing from the spirit and scope of the invention. Accordingly, other embodiments are within the scope of the following claims.

1. A method of transferring messages from a first system executing a first software application to a second system executing a second software application, wherein the messages contain a current state for a document, the method comprising:
in response to an action in the first system affecting the current state, posting for delivery a message containing the current state of the document to an outgoing message channel in a message exchange layer contained within the first system;
at a time for asynchronous message transfer, and if a first quality of service type is specified for the transfer of messages containing the current state of the document, forwarding only a latest message containing the document that is posted to the outgoing message channel for transfer to the second system.

2. The method of claim 1 wherein the document is a database object having attributes and values for the attributes.

3. The method of claim 1 wherein the document includes information derived from an object having attributes and attribute value.

4. The method of claim 1 further comprising, if a message containing the document is posted for delivery in the outgoing message channel and an earlier message containing the document is already contained in the channel, and if the first quality of service type is specified for the transfer of messages containing the current state of the document, discarding the earlier message from the channel.

5. The method of claim 1 further comprising, at the time for asynchronous message transfer, and if a second quality of service type is specified for the transfer of messages containing the current state of the document, forwarding in order all messages posted to the outgoing message channel for transfer to the second system.

6. The method of claim 1 further comprising receiving the forwarded message in an incoming channel in a message exchange layer contained within the second system.

7. The method of claim 6 further comprising, at a time for processing any message that contains the current state of the document and that is contained in the incoming channel, and if the first quality of service type is specified for the processing of messages containing the document received in the incoming channel, processing only a latest message containing the document that is received in the incoming message channel since a previous time for processing any message containing the current state of the document that is received in the incoming channel.

8. The method of claim 6 wherein:
the second system does not support the first quality of service type; and
the method further comprises, at a time for processing any message that contains the current state of the document and that is contained in the incoming channel, and if a second quality of service type is specified for the processing of messages containing the document that are received in the incoming channel, processing in order all messages received in the incoming channel since a previous time when any messages containing the document and received in the incoming channel were processed.

9. The method of claim 1 further comprising receiving the forwarded message in a channel in an intermediate message hub system.

10. The method of claim 9 further comprising, at a time for forwarding any message that contains the current state of the document and that is contained in the message hub system channel, and if the first quality of service type is specified for the transfer of messages containing the current state of the document, forwarding only a latest message containing the document that is received in the message hub channel for transfer to the second system since a previous time when any messages containing the document were forwarded from the message hub system channel.

11. The method of claim 9 wherein:
the intermediate message hub system does not support the first quality of service type; and
the method further comprises, at a time for forwarding any message that contains the current state of the document and that is contained in the message hub system channel, and if a second quality of service type is specified for the transfer of messages containing the current state of the document, forwarding in order all messages received in the message hub channel for transfer to the second system since a previous time when any messages containing the document were forwarded from the message hub system channel.

12. The method of claim 1 wherein the first system is a sales order system and the document is a sales order document.

13. The method of claim 1 wherein the first system is a sales order system and the document contains delivery information derived from a sales order document.

14. The method of claim 12 wherein the second system is a logistics system that is used to coordinate delivery of the subject of the sales order.

15. The method of claim 1 wherein the first system is a call center sales system in which call center agent enter sales requests.

16. The method of claim 15 wherein the document is a sales order.

17. The method of claim 15 wherein the document contains delivery information derived from a sales order document.

18. The method of claim 1 wherein the outgoing message channel is established for a posted message containing the current state of the document, and wherein any subsequent messages containing the current state of the document are posted to the same outgoing message channel.

19. The method of claim 1 wherein the document is a master data record that is to be replicated to the second system.

20. The method of claim 1 wherein the master data record is a record of a business contact including a name and an address of the contact.

21. The method of claim 1 wherein the first system is a mobile computing system and the time for asynchronous message transfer occurs when the mobile computing system is interconnected with a system wherein data transfer from the outgoing channel for forwarding to the second system is possible.

22. A computer program product containing executable instructions that when executed cause a processor to:
in response to receiving, in a messaging transport layer, a message that contains a complete state of a document and that represents information to be transferred from a first computing system to a second computing system, store the message in a message channel designated for messages containing the document; and
at a time for asynchronous message transfer, and if a first quality of service type is specified for the transfer of messages containing the current state of the document, forward only a latest message containing the document that is stored in the message channel for transfer to the second system.
